(19) United States
(12) Patent Application Publication
(10) Pub. No.: US 2016/0119960 A1
(43) Pub. Date: Apr. 28, 2016

(54) SYSTEM AND METHOD FOR CONNECTING AN APPLIANCE TO A HOME WIRELESS NETWORK

(71) Applicant: General Electric Company, Schenectady, NY (US)

(72) Inventor: Christopher Matthew Baker, Louisville, KY (US)

(21) Appl. No.: 14/521,555

(22) Filed: Oct. 23, 2014

(51) Int. Cl. H04W 76/02; H04M 1/725; H04W 4/00; H04W 40/24; H04M 19/04

(52) U.S. Cl. CPC H04W 76/021; H04W 40/246; H04M 19/047; H04W 4/005; H04M 1/72533

(57) ABSTRACT

Methods, devices and systems are provided that enable connection of an appliance to a home wireless network. A programmable device, such as a smartphone, is programmed to produce vibrations based on the SSID and password word of a home wireless system. A vibration sensor associated with the appliance produces a signal based on the vibrations when the programmable device is activated and placed in contact with the appliance. A controller within the appliance decodes the vibration signals and uses the decoded information to program a wireless radio associated with the appliance to enable connection to the wireless network.

### FIELD OF THE INVENTION

The present subject matter relates to home appliances. More particularly, the present subject matter relates to systems and methods for connecting appliances to a home wireless network.

### BACKGROUND OF THE INVENTION

Recently interest has been increasing in the development of the so called, Internet of Things (IoT). With respect to individuals, particularly home owners, interest has developed regarding Internet, or at least home network, connected appliances, for example refrigerators, ovens, cooktops, laundry machines, and others.

One disadvantage in implementing installation of such connected appliances, however, resides in the actual process of connecting the appliance to the Internet or owner's home network. For example, certain data must be supplied to the appliance before it can communicate with the Internet of an owner's home network. In prior arrangements, data has been entered by way of keyboards or input panels associated either permanently, as being built in to the appliance, or temporarily, as being temporarily coupled to the appliance by way of wired or wireless connections. In some instances, flashing lights have been used to communicate with an appliance for programming purposes.

While these techniques are effective to implement connection of appliances and other devices to the Internet or an owner's home network, each has certain disadvantages. For example, the incorporation of a keyboard or other input panel increases the overall cost of the appliance. Similarly, wired or wireless connections of programming devices such as laptop computers requires that either a connector be available in the appliance or an independent WiFi access point be incorporated into the appliance for communication with the programming device. The use of flashing lights for programming requires that the appliance be capable of responding to such light flashes which would be disadvantageous if, during programming or later operation of the appliance random light normally present in the appliance's operational environment were to interfere with programming attempts or later, inadvertently, alter the appliance's programming.

Thus, a need exists for systems and methods for connecting an appliance to a home wireless network that is simple to implement and easy for individuals with limited technical experience to successfully complete.

### BRIEF DESCRIPTION OF THE INVENTION

Aspects and advantages of the invention will be set forth in part in the following description, or may be obvious from the description, or may be learned through practice of the invention.

One exemplary embodiment of the present disclosure is directed to a method for enabling wireless communications between a device and a wireless network. The method calls for generating encoded vibrations, coupling the vibrations to the device, decoding the vibrations, and programming a wireless radio associated with the device based on the decoded vibrations.

Another exemplary embodiment of the present disclosure is directed to a system for enabling wireless communications between an appliance and a wireless network. In an exemplary embodiment, the system includes a device configured to produce encoded vibrations, a vibration sensor configured to provide signals based on received encoded vibrations, a wireless radio, and a controller. In such system the vibration sensor, wireless radio and controller are associated with the appliance, and the controller is configured to decode the signals and to program the wireless radio based on the decoded signals provided by the vibration sensor.

A further exemplary embodiment of the present disclosure is directed to a system for enabling wireless communications between an appliance and a wireless network. In such a system a device configured to produce encoded vibrations is provided and an appliance is provided with a vibration sensor configured to provide signals based on received encoded vibrations, a wireless radio, and a controller. In such system the controller is configured to decode signals produced by the vibration sensor and to program the wireless radio based on the decoded signals.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a block diagram of an exemplary appliance constructed in accordance with the present subject matter; and

FIG. 2 provides flow chart for implementing appliance commissioning in accordance with the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present subject matter is directed to a system and method for enabling commissioning, that is, connection of an appliance to a user's home wireless network. In many cases, the process of connecting an appliance to a home network is confusing for many users. In accordance with the present subject matter, to simplify and improve the user experience, a phone, more particularly, a smartphone, but more generally, a smart device, is configured to send required wireless credentials to an appliance by generating vibrations while the smart device is held in physical contact with the appliance.

It should be appreciated that while the present disclosure generally makes reference to the use of a smart device, such smart device is intended to correspond to any device that may be programmed to produce vibrations that may be coupled to an appliance by physical contact with the appliance. In this context, devices such as, but not limited to, smartphones and tablet devices may be used to implement the present subject matter.

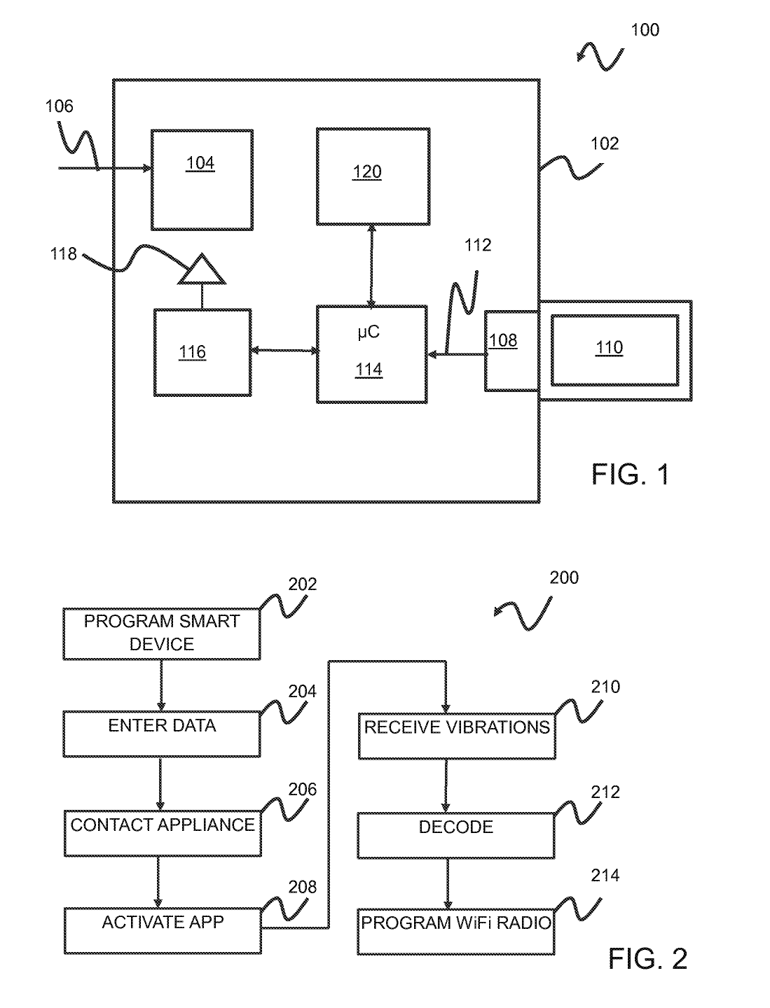

Referring more particularly to the presently disclosed subject matter and with reference to FIG. 1, a block diagram of an exemplary appliance 100 constructed in accordance with the present subject matter. As illustrated in FIG. 1, appliance 100 includes a housing 102 containing therein a power supply 104 configured to receive AC power at input 106 and to supply operating power to other components within appliance 100. Energy from power supply 104 may be supplied as alternating current (AC) and/or direct current (DC) as required by the other components.

In accordance with the present subject matter, appliance 100 is provided with a vibration sensor 108 that may be located within or on appliance 100 so as to be easily accessible for a user to physically couple vibrations produced by a smart device 110 to the vibration sensor 108. In some embodiments, sensor 108 may be located on a control panel associated with appliance 100 while in other embodiments, sensor 108 may be attached to a designated portion within or on appliance housing 102. It should be appreciated that vibration sensor 108 may be positioned such that other material, for example an external housing 102 of appliance 100, may be interposed between vibration sensor 108 and a vibration producing smart device 110. In any event, however, per present disclosure, sensor 108 remains able to receive vibration signals from vibrating smart device 110.

With continued reference to FIG. 1, it will be seen that block diagram 100 further illustrates a microcontroller 114 configured to receive signals via signal line 112 from sensor 108. It should be appreciated that other processing devices or systems may be employed instead of microcontroller 114. In accordance with the present subject matter, in order to commission appliance 100 for communications with a user's home network, the user enters their wireless Service Set Identifier (SSID) and password into an application installed on smart device 110. Data may be entered using a physical or virtual keyboard associated with the smart device. In some embodiments, data may be entered using other techniques including, without limitation, reading data already stored in the smart device, for example data relating to the user's home network to which the smart device may already be connected. Smart device 110 may then be placed against appliance 100 as illustrated.

With smart device 110 in physical contact with appliance 100, the smart device 110 application encodes the wireless SSID and password into a vibration signal. Appliance 100 listens for vibration signals received via sensor 108 and decodes the signal in microcontroller 114 into the wireless SSID and password entered into the smart device program by the user. The decoded information may then be sent to an appliance WiFi radio 116 to allow communications with the user's home network (not separately illustrated) via WiFi radio 116′s antenna 118. Appliance 100 may then connect to the home network whereby at least selected appliance functions may be controlled by way of appliance controller 120. In certain embodiments of the present subject matter, appliance control 120 may be controlled via microcontroller 114 or the functionality of appliance controller 120 may be incorporated within microcontroller 114.

With reference to FIG. 2 there is illustrated a flow chart 200 for implementing appliance commissioning in accordance with the present subject matter. As a first step for implementing the present subject matter, per step 202, an application (app) configured to encode wireless configuration information and to enable operations of the smart device to perform appliance commissioning is installed on the smart device. Installation of apps on smart devices is a well understood process and thus will not be further described herein.

At step 204 a user activates the installed app and enters programming data including at least the SSID and password associated with the user's home wireless network. This process is similar to entering similar information for other smart devices including smartphones and tablet computers that are commonly in use and often are also connected to a user's home network.

At step 206 a user places the now programmed smart device in physical contact with the appliance and then, at step 208, activates the app to cause the smart device to vibrate based on encoded versions of the previously entered SSID and password information.

At step 210, vibrations from the smart device are received by a vibration sensor associated with the appliance and the received vibrations are decoded at step 212 to reproduce the SSID and password information entered into the app by the user. At step 214 the decoded information is applied to a wireless radio component associated with the appliance so as to enable the wireless radio component to communicate with the user's home network so as to enable communications via wireless (WiFi) signals over the home network to control at least selected operations of the appliance.

By employing the technology of the present subject matter a user is not required to switch back and forth between wireless networks in order to send wireless credentials to an appliance as has been necessary with prior appliance incorporating their own access point for programming. Thus any requirements for a user to change wireless networks on their smart device has been entirely eliminated thereby significantly simplifying appliance commissioning while also allowing for reduced costs of the appliance due to elimination of previously required elements, i.e., a separate access point for programming.

It should be appreciated that while the present description has been directed primarily to home appliances, aspects of the present subject matter may also be applied to other devices. For example, smart device generated vibrations as described herein may be used not only to provide programming information to enable coupling of an appliance to the Internet, but may also be used to program other devices such as door locks and other home security devices, garage door openers, and other devices that require only an initial, or limited number of programming operations and where relatively inexpensive communication options are desirable.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for enabling wireless communications between a device and a wireless network, comprising:
generating encoded vibrations;
coupling the vibrations to the device;
decoding the vibrations; and
programming a wireless radio associated with the device based on the decoded vibrations.

2. A method as in claim 1, wherein generating encoded vibrations comprises programming a smart device to produce the encoded vibrations.

3. A method as in claim 2, wherein programming comprises programming a smart device to convert entered data to encoded vibrations.

4. A method as in claim 2, wherein coupling comprises physically coupling the smart device to a vibration sensor associated with the device.

5. A method as in claim 2, wherein programming a smart device comprises programming a smartphone.

6. A method as in claim 1, wherein generating encoded vibrations comprises generating vibrations based on the wireless network's SSID and password.

7. A device, comprising:
a vibration sensor;
a controller; and
a wireless radio,
wherein said vibration sensor is configured to provide a signal based on received vibrations, and
wherein said controller is configured to program said wireless radio based on said signal to permit communications with a wireless network.

8. A device as in claim 7, wherein said wireless radio is a WiFi radio.

9. A device as in claim 7, wherein said signal contains SSID and password information.

10. A device as in claim 7, wherein said device comprises one of an appliance, an oven, a cooktop, a refrigerator, a laundry washing machine, and a laundry drying machine.

11. A system for enabling wireless communications between an appliance and a wireless network, comprising:
a device configured to produce encoded vibrations; and
an appliance including a vibration sensor configured to provide signals based on received encoded vibrations, a wireless radio, and a controller;
wherein said controller is configured to decode said signals and to program said wireless radio based on the decoded signals.

12. A system as in claim 11, wherein said device comprises a smart device programmed to produce encoded vibrations.

13. A system as in claim 12, wherein said smart device is configured to convert entered data to encoded vibrations.

14. A system as in claim 12, wherein said vibration sensor is configured to receive said encoded vibrations through mechanical coupling with said smart device.

15. A system as in claim 12, wherein said smart device comprises a smartphone.

16. A system as in claim 11, wherein said encoded vibrations comprise vibrations based on the wireless network's SSID and password.

17. A system wherein said appliance comprises comprises one of an oven, a cooktop, a refrigerator, a laundry washing machine, and a laundry drying machine.
